(19) United States
(12) Patent Application Publication
(10) Pub. No.: US 2008/0206646 A1
(43) Pub. Date: Aug. 28, 2008

(54) ALKALINE SECONDARY BATTERY WITH SEPARATOR CONTAINING AROMATIC POLYAMIDE FIBER

(75) Inventors: Tetsuya KIKUCHI, Osaka (JP); Kazuki SHIMOZONO, Osaka (JP); Chihiro FUJISAWA, Osaka (JP); Kazuo TOMIMOTO, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/038,484

(22) Filed: Feb. 27, 2008

(30) Foreign Application Priority Data
Feb. 27, 2007 (JP) 2007-47212

(51) Int. Cl. H01M 2/14; H01M 10/04

(52) U.S. Cl. 429/246

(57) ABSTRACT

An electrode assembly of an alkaline secondary battery includes positive and negative electrodes disposed to face each other via a separator sandwiched therebetween. The separator has a dual-layer structure composed of a main-fiber nonwoven layer and an aromatic-polyamide-fiber nonwoven layer that are laminated in the thickness direction. The main-fiber nonwoven layer contains nylon as main fiber and does not contain aromatic-polyamide-fiber. In the electrode assembly, the separator is so disposed that the aromatic-polyamide-fiber nonwoven fabric layer faces toward the negative electrode.

### BACKGROUND OF THE INVENTION

(1) Field of the Invention

The present invention relates to an alkaline secondary battery having a separator into which aromatic polyamide fiber is mixed. More particularly, the present invention relates to the construction of the separator and to the disposition of positive and negative electrodes relatively to the separator.

(2) Description of the Related Art

Alkaline secondary batteries are widely used as a large current power source for various applications, including an electric automobile, an electric motorcycle, an electric bicycle, and an electric tool.

Generally, an alkaline secondary battery includes an electrode assembly that is formed by spirally winding positive and negative electrodes that are disposed to face each other via a separator sandwiched therebetween. The electrode assembly is enclosed in an external can and saturated with an electrolytic solution. The opening of the external can is closed with a closure cap. The positive and negative electrodes each have an electrode substrate (tab) and are so disposed in the electrode assembly that the respective tabs each extend beyond a different one of opposite edges of the separator. The respective electrode substrates are connected to either of the external can and the closure cap via a corresponding one of positive- and negative-current collecting leads.

Alkaline secondary batteries are desired to have high output and high energy density. In order to satisfy the needs, developments have been made to reduce the thickness of the separator, which does not contribute to charge and discharge reaction of the battery. However, it is not desirable to simply reduce the separator thickness in view of the following risk. That is, upon receipt of vibrations expected to occur during manufacturing or use of the battery, a broken piece of electrodes present within the electrode assembly may cause a rupture of the separator and consequently cause an internal short-circuit.

Regarding alkaline secondary batteries, several attempts have been made to reduce the thickness of the separator without incurring the risk of an internal short-circuit. Examples of such attempts include JP patent application publication No. 2001-266832 and JP patent application publication No. 2005-71868. Specifically speaking, the publications suggest to employ a separator into which aromatic polyamide fiber is mixed. With the separator disclosed in the publications, the separator thickness is reduced and thus the energy density of the battery is increased, without sacrificing the strength of the separator to ensure high resistance to short-circuit.

According to JP patent application publications No. 2001-266832 and No. 2005-71868, however, the content of aromatic polyamide fiber in the separator needs to be high in order to successfully reduce the thickness of the separator. Unfortunately, aromatic polyamide fiber is relatively low in hydrophilicity. Thus, difficulty of holding the electrolytic solution increases with increase in the content of aromatic polyamide fiber.

### SUMMARY OF THE INVENTION

The present invention is made in view of the above problems and aims to provide an alkaline secondary battery having a separator with improved strength without the need to increase the content of aromatic polyamide fiber, so that high energy density and high short-circuit resistance are both ensured.

The present inventors have found that the following arrangement achieves to improve the resistance to short-circuit without increasing the content of aromatic polyamide fiber mixed in the separator. That is, instead of spreading aromatic polyamide fiber substantially uniformly across the thickness direction of the separator, the separator is provided with a layer which is high in the content of aromatic polyamide fiber. In other words, the separator has a multi-layer structure and one of the layers disposed to form one main surface of the separator is high in the content of aromatic polyamide fiber. Another one of the layers disposed to form another main surface of the separator contains fiber whose property of holding electrolytic solution is higher than aromatic polyamide fiber (one example of such fiber includes aliphatic polyamide fiber). With this arrangement, the resulting separator is relatively low in the content of aromatic polyamide fiber but high in both the short-circuit resistance and the property of holding electrolytic solution.

It should be noted however, the separator having the above construction naturally varies in distribution of electrolytic solution within the battery, as compared with a battery having a conventional separator in which aromatic polyamide fiber is mixed substantially uniformly across the separator. That is, an electrode assembly may be so constructed that the layer with a higher content of aromatic polyamide fiber faces away from the negative electrode. As a result, the negative electrode tends to hold a larger amount of electrolyte solution. Thus, an alkaline secondary battery having such an electrode assembly involves a problem that the gas absorption by the negative electrode at the time of battery charging is obstructed and consequently the internal pressure rises.

In view of the above findings, the alkaline secondary battery according to the present invention has an electrode assembly and an electrolytic solution held in the electrode assembly. The electrode assembly includes a positive electrode, a negative electrode, and a separator and the positive and negative electrodes are disposed to face each other via the separator sandwiched therebetween. In addition, the separator according to the present invention has the following construction.

The separator of the alkaline secondary battery according to the present invention contains: aromatic polyamide fiber; and fiber having higher property of holding the electrolytic solution than that of the aromatic polyamide fiber. In addition, the separator includes a first layer containing the higher-liquid-holding fiber as a main component and a second layer containing the aromatic polyamide fiber at a density higher than that in the first layer. The first and second layers are exposed as first and second main surfaces of the separator respectively. In the electrode assembly of the alkaline secondary battery according to the present invention, the separator is so disposed that the second main surface (the main surface on which the second layer is exposed) faces toward the negative electrode.

Since the separator of the alkaline secondary battery according to the present invention includes the first layer mainly composed of fiber having a higher-liquid-holding property, the first layer ensures that the separator sufficiently holds electrolytic solution. On the other hand, the second layer of the separator is higher than the first layer in density of aromatic polyamide fiber. Thus, the strength of the second layer is higher than that of the first layer.

In addition, the separator of the alkaline secondary battery according to the present invention includes the second layer (higher-strength layer) that contains aromatic polyamide fiber at high density. The second layer possesses adequate strength even if the thickness is relatively thin. Thus, the separator can be made thinner without compromising strength and thus has excellent resistance to short-circuit. That is, aromatic polyamide fiber has higher tensile strength and higher corrosion resistance as compared with, for example, aliphatic polyamide fiber. Consequently, with the alkaline secondary battery the according to the present invention, the separator is allowed to be made thinner while ensuring sufficient resistance to short-circuit and without the need to increase the content of aromatic polyamide fiber.

Further, in the alkaline secondary battery according to the present invention, the separator includes the second layer, which is a higher-strength layer, exposed on one of the main surfaces of the separator. The separator is so disposed that the main surface on which the second layer is exposed faces toward the negative electrode. This construction ensures that gas absorption by the negative electrode at the time of charging is not reduced. This advantageous effect that gas absorption is not reduced is believed to be achieved by virtue of the construction of the alkaline secondary battery according to the present invention. That is, the separator includes the first layer composed mainly of higher-liquid-holding fiber and the first layer is exposed on the other main surface of the separator. The separator is so disposed that the main surface on which then first layer is exposed (i.e., the other main surface) faces toward the positive electrode. With this construction, excessive supply of the electrolytic solution to the negative electrode is prevented. Thus, oxygen gas generated by the positive electrode at the time of charging is allowed to reliably make contact with negative active material.

Since the alkaline secondary battery according to the present invention has the separator that includes the second layer containing aromatic polyamide fiber at high density, the resistance to short-circuit is increased and the thickness of the separator is allowed to be reduced. In addition, since the electrode assembly includes the separator in a particular deposition relatively to the positive and negative electrodes, a rise of internal pressure at the time of charging is suppressed.

The separator of the alkaline secondary battery according to the present invention may contain aliphatic polyamide fiber as the fiber whose property of holding electrolytic solution is higher than aromatic polyamide fiber. Although the “fiber whose property of holding electrolytic solution is higher than aromatic polyamide fiber” usable in the alkaline secondary battery according to the present invention is not limited to aliphatic polyamide fiber, in the light of the state of the art, aliphatic polyamide fiber is desirable in view of the property as a separator material or the property of holding electrolytic solution.

Further, the alkaline secondary battery according to the present invention may be modified to provide the following variations. The separator of the alkaline secondary battery according to the present invention may be modified to include a first layer that contains no aromatic polyamide fiber. In addition, the separator of this variation may have a dual-layer structure including the first and second layers laminated in the thickness direction of the separator. Note that the layer that “contains no aromatic polyamide fiber” means that no aromatic polyamide fiber is intentionally added in a manufacturing process. That is, such a layer may contain aromatic polyamide fiber as impurities unintentionally mixed during manufacturing.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is an oblique (partly cross-sectional) view showing the construction of an alkaline secondary battery 1 according to an embodiment of the present invention;

FIG. 2 is a view schematically showing the relative disposition of a positive electrode 11, a negative electrode 12, and a separator 13 that constitute an electrode assembly 10 of the alkaline secondary battery 1;

FIG. 3 is a block diagram illustrating steps of manufacturing the separator 13 according to the embodiment;

FIG. 4 is a view schematically showing a hot processing step in the manufacturing of the separator 13;

FIG. 5 is a view schematically showing the construction of an electrode assembly 80 included in an alkaline secondary battery according to Comparative Example 1;

FIG. 6A is a view schematically showing the construction of an electrode assembly 90 included in an alkaline secondary battery according to Comparative Example 2; and

FIG. 6B is a block diagram illustrating steps of manufacturing a separator 93 included in the electrode assembly 90.

### DESCRIPTION OF THE PREFERRED EMBODIMENT

The following describes a best mode for carrying out the present invention by way of an embodiment. Note that the embodiment is presented below for the purpose of illustrating the construction and advantages of the present invention. It is naturally appreciated that the present invention is not limited to the specific embodiment below, except for its gist and essential features.

### 1. Construction

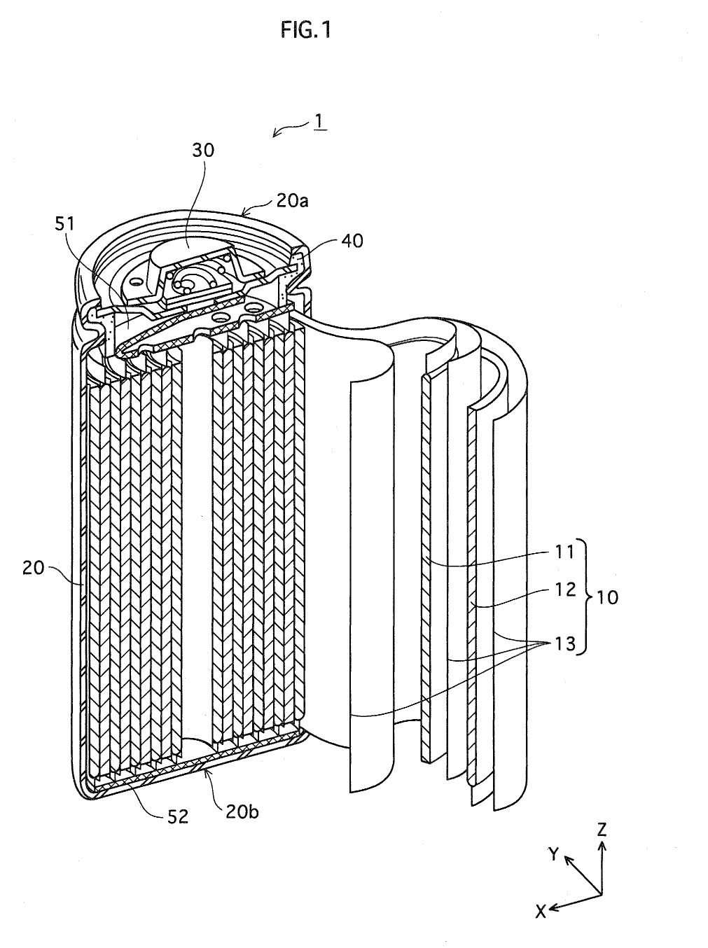

With reference to FIG. 1, the construction of an alkaline secondary battery 1 according to the embodiment of the present invention is described.

As illustrated in FIG. 1, an external can 20 is a tubular member having an open end 20a and a bottom 20b and housing an electrode assembly 10 therein. The electrode assembly 10 is a rolled body formed as described below. The electrode assembly 10 is saturated with an electrolytic solution (not illustrated) and the open end 20a of the external can 20 is sealed with a closure cap 30. A gasket 40 is interposed between the external can 20 and the closure cap 30.

The electrode assembly 10 includes a positive electrode 11, a negative electrode 12, and a separator 13 each of which is shaped in a strip. To form the electrode assembly 10, the negative electrodes 12 and 13 are laminated to sandwich the separator therebetween and the laminate is spirally wound around. With reference to the Z direction of the electrode assembly 10 shown in FIG. 1, the positive electrode 11 has a tab that extends beyond the upper edge of the separator 13. Similarly, the negative electrode 12 has a tab that extends beyond the lower edge of the separator 13.

The electrode assembly 10 is provided with a positive-current collecting plate 51 connected at the top of the electrode assembly 10 in the Z direction and also provided with a negative-current collecting plate 52 connected at the bottom. The positive-current collecting plate 51 has a rectangular lead that is folded to be in contact with the inner bottom surface of the closure cap 30. The negative-current collecting plate 52 is bonded to an inner surface of the bottom 20b of the external can 20.

### 2. Construction of Separator 13 and Electrode Assembly 10

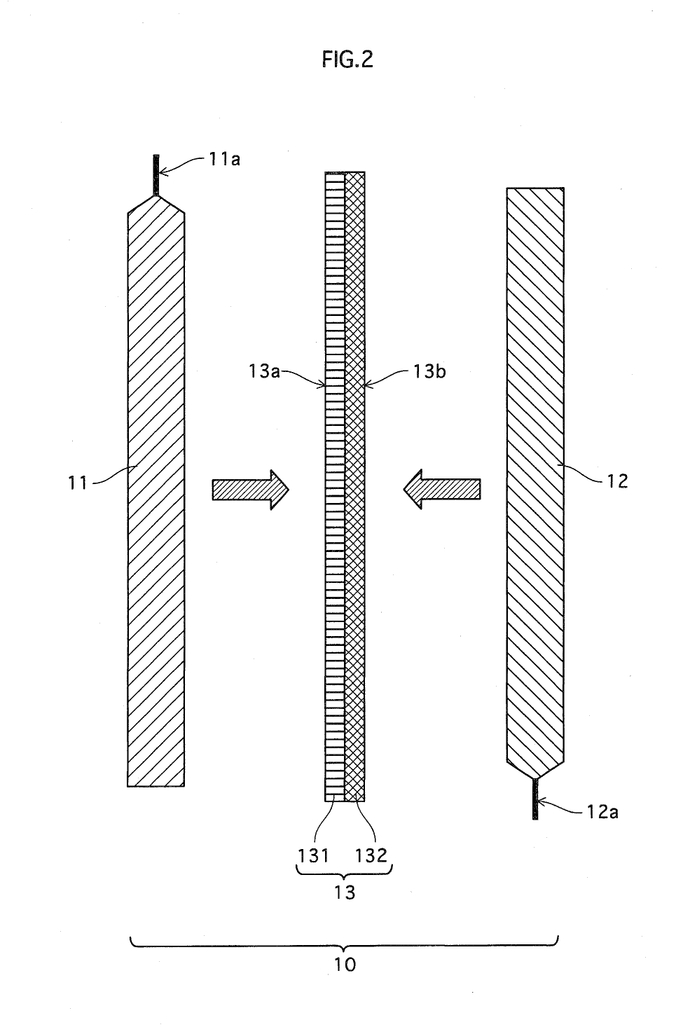

The following describes the construction of the separator 13 that is the most characterizing feature of the alkaline secondary battery 1 according to the embodiment. The following also describes the detailed construction of the electrode assembly 10 that includes the separator 13 in addition to other components. In the description, reference is made to FIG. 2.

### (1) Construction of Separator 13

As illustrated in FIG. 2, the separator 13 of the alkaline secondary battery 1 according to the embodiment is composed of two layers 131 and 132 stuck together in the thickness direction of the separator 13. Out of the two layers, the layer 131 is a layer of nonwoven cloth containing Nylon 66 as main fiber (hereinafter, this layer is referred to as the “main-fiber nonwoven layer 131”). The main-fiber nonwoven layer 131 does not contain aromatic polyamide fiber.

The other layer 132 is a layer of nonwoven cloth containing aromatic polyamide fiber (hereinafter, this layer is referred to as the “aromatic-polyamide-fiber nonwoven layer 132”). Note that both the main-fiber nonwoven layer 131 and the aromatic-polyamide-fiber nonwoven layer 132 contain sheath-core bicomponent fiber.

As described above, the separator 13 according to the embodiment is composed of the main-fiber nonwoven layer 131 and the aromatic-polyamide-fiber nonwoven layer 132 that are stuck together in the thickness direction by hot pressing. The separator 13 contains the main fiber (Nylon 66), the aromatic polyamide fiber and adhesive fiber (Nylon 66 as core fiber+Nylon 12 as sheath fiber) at the ratio (by mass) of 5:1:5 approximately. The thickness ratio between the main-fiber nonwoven layer 131 and the aromatic-polyamide-fiber nonwoven layer 132 is 3:1 approximately. In addition, the separator 13 measures approximately 0.13 mm in total thickens and 55 g/m² in areal weight.

Since the separator 13 has the dual-layer structure described above, aromatic polyamide fiber is not exposed on the main surface 13a constituted by the main-fiber nonwoven layer 131. On the other hand, aromatic polyamide fiber is exposed on the other main surface 13b constituted by the aromatic-polyamide-fiber nonwoven layer 132.

### (2) Detailed Construction of Electrode Assembly 10

As illustrated in FIG. 2, in the electrode assembly 10 according to the embodiment, the dual-layer separator 13 is so disposed that the main surface 13a faces toward the positive electrode 11, whereas the main surface 13b faces toward the negative electrode 12. In other words, the positive electrode 11 confronts the main-fiber nonwoven layer 131, whereas the negative electrode 12 confronts the aromatic-polyamide-fiber nonwoven layer 132.

Note that the tab 11a of the positive electrode 11 extends beyond the upper edge of the separator 13 in the widthwise direction and bonded to the positive-current collecting plate 51. Similarly, the tab 12a of the negative electrode 12 extends beyond the lower edge of the separator 13 in the widthwise direction and bonded to the negative-current collecting plate 52. (See FIG. 1)

### 3. Method of Manufacturing Separator 13

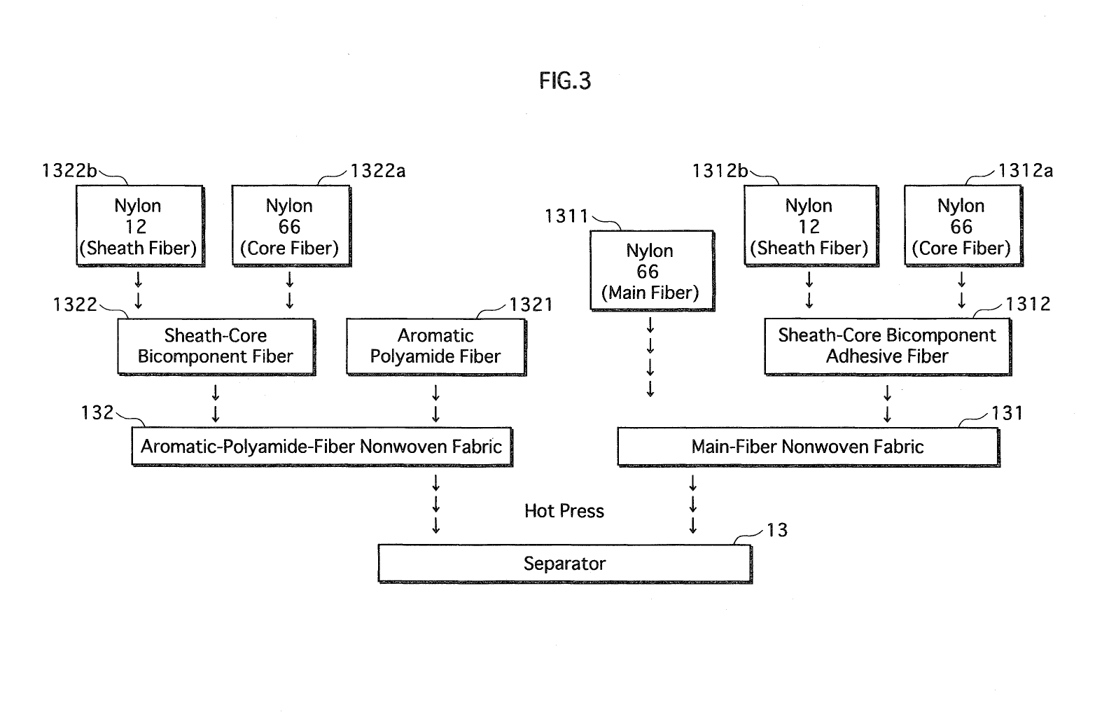

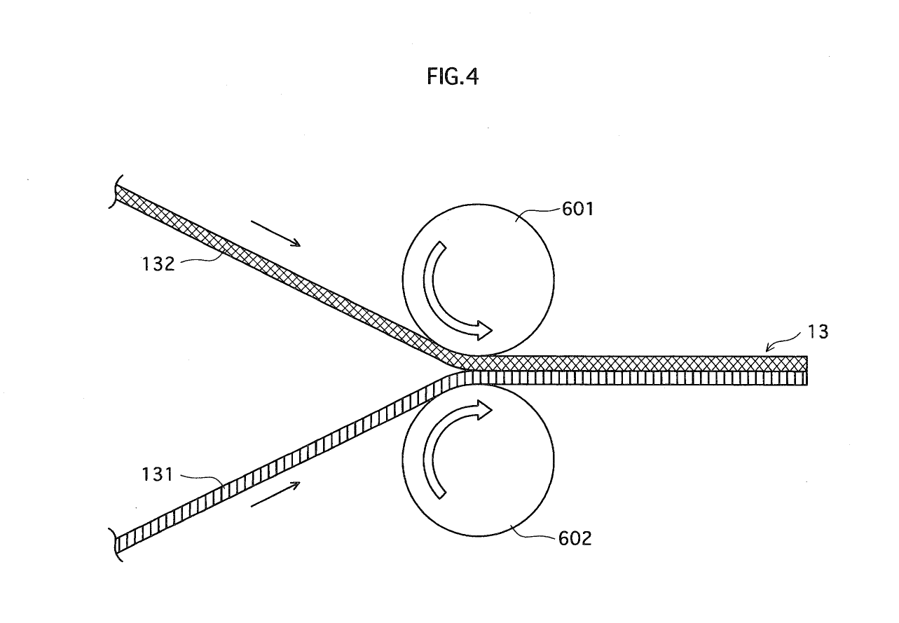

The following describes a method of manufacturing the separator 13 according to the embodiment, with reference to FIGS. 3 and 4.

### (1) Manufacturing of Main-Fiber Nonwoven Layer 131

As illustrated in FIG. 3, the main-fiber nonwoven layer 131 is manufactured in the following manner. First of all, main fiber 1311 composed of Nylon 66 and sheath-core bicomponent fiber 1312 are mixed at the ratio (by mass) of 5:3 approximately and dispersed to form a slurry. The slurry is then formed into the main-fiber nonwoven layer 131 by using a known wet foaming method. The sheath-core bicomponent fiber 1312 contains Nylon 66 as core fiber 1312a and Nylon 12 as sheath fiber 1312b.

### (2) Manufacturing of Aromatic-Polyamide-Fiber Nonwoven Layer 132

The aromatic-polyamide-fiber nonwoven layer 132 is manufactured in the following manner. First of all, aromatic polyamide fiber 1321 and sheath-core bicomponent fiber 1322 are mixed at the ratio (by mass) of 1:2 approximately and dispersed to form a slurry. The slurry is then formed into the aromatic polyamide fiber nonwoven layer 132 using a known wet foaming method similarly to the above.

Note that the sheath-core bicomponent fiber 1322 used to manufacture the aromatic-polyamide-fiber nonwoven layer 132 contains Nylon 66 as core fiber 1322a and Nylon 12 as sheath fiber 1322b, just like the sheath-core bicomponent fiber 1312 used to manufacture the main-fiber nonwoven layer 131.

### (3) Sticking of Main-Fiber Nonwoven Layer 131 and Aromatic-Polyamide-Fiber Nonwoven Layer 132

The main-fiber nonwoven layer 131 and the aromatic-polyamide-fiber nonwoven layer 132 manufactured in the above-described manner are stuck together by hot-pressing. More specifically, as in example shown in FIG. 4, the main-fiber nonwoven layer 131 and the aromatic-polyamide-fiber nonwoven layer 132 are stuck together by passing between a pair of heated hot-pressing rollers 601 and 602. As a result, the dual-layer separator 13 is formed.

The details of the main-fiber nonwoven layer 131 and the aromatic-polyamide-fiber nonwoven layer 132 are as follows. The content ratio (by mass) of the main fiber (Nylon 66) 1311, the aromatic polyamide fiber 1321, and adhesive fiber (Nylon 66 as core fiber+Nylon 12 as sheath fiber) 1312 and 1322 contained in the separator 13 are 5:1:5 approximately. In addition, the thickness ratio between the main-fiber nonwoven layer 131 and the aromatic-polyamide-fiber nonwoven layer 132 is 3:1 approximately. In addition, the separator 13 is adjusted to measure approximately 0.13 mm in total thickens and 55 g/m² in areal weight.

### 4. Advantages of Alkaline Secondary Battery 1

As shown in FIG. 2, the electrode assembly 10 of the alkaline secondary battery 1 according to the embodiment includes the separator 13 has a dual-layer structure composed of the main-fiber nonwoven layer 131 and the aromatic-polyamide-fiber nonwoven layer 132. In addition, the electrode assembly 10 is so configured that the main surface 13b of the separator 13 on which the aromatic-polyamide-fiber nonwoven layer 132 is exposed faces toward the negative electrode 12. As described above, in the electrode assembly 10, the aromatic polyamide fiber 1321 makes surface contact with the negative electrode 12. As a consequence, it is avoided that the negative electrode 12 holds an excessive amount of electrolytic solution.

That is, the alkaline secondary battery 1 according to the embodiment is so configured that the negative electrode 12 faces toward the aromatic-polyamide-fiber nonwoven layer 132 containing the aromatic polyamide fiber 1321 whose property of holding electrolytic solution is lower than the main fiber 1311. This configuration allows oxygen generated by the positive electrode 11 to more easily contact with negative active material at the time of charging. Thus, the internal pressure is maintained low at the time of charging.

The aromatic-polyamide-fiber nonwoven layer 132, which is the other one of the two layers of the separator 13, has a high mass content (high density) of aromatic polyamide fiber 1321. As a consequence, the separator 13 achieves higher strength than that of a separator through which the same content of aromatic-polyamide-fiber nonwoven fabric is spread substantially uniformly. By virtue of this improved strength, the alkaline secondary battery 1 according to the embodiment is capable of suppressing occurrence of short-circuit even if the thickness of the separator 13 is reduced.

### 5. Confirmation of Superiority

The following describes the experiments conducted to confirm the superiority of the present invention.

### (1) Example

As Example of the present invention, battery samples substantially identical in construction to the alkaline secondary battery 1 according to the embodiment were prepared. Each battery sample was an SC size nickel-cadmium secondary battery (nominal capacity: 2500 mAh). The positive electrode 11 was made of a sintered nickel positive electrode, whereas the negative electrode 12 was made of a sintered cadmium negative electrode. A total of 200 battery samples of Example were prepared.

### (2) Comparative Example 1

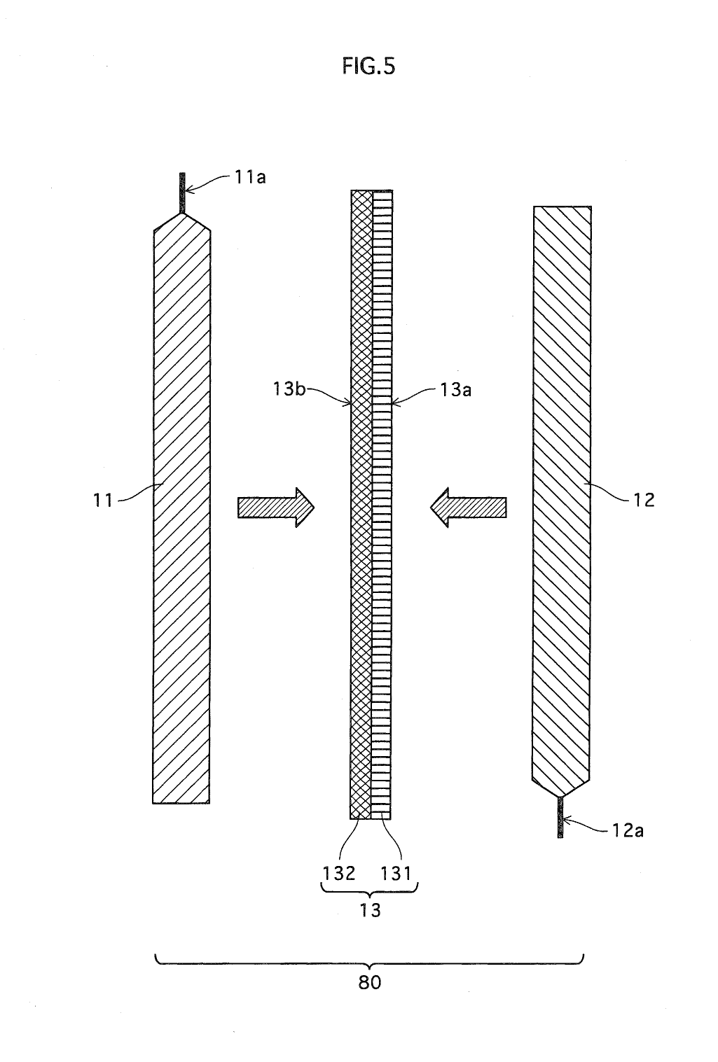

As Comparative Example 1, battery samples were prepared and the difference with the battery samples of Example was found in disposition of the positive and negative electrodes 11 and 12 relatively to the separator 13. More specifically, as illustrated in FIG. 5, each battery sample of Comparative Example 1 was provided with an electrode assembly 80. In the electrode assembly 80, the separator 13 was so disposed that the main surface 13a constituted by the main-fiber nonwoven layer 131 faced toward the negative electrode 12 and the main surface 13b constituted by the aromatic-polyamide-fiber nonwoven layer 132 faced toward the positive electrode 11.

Note that the battery samples of Comparative Example 1 were identical in construction to the battery samples of Example, except for the electrode assembly 80. A total of 200 battery samples of Comparative Example 1 were prepared.

### (3) Comparative Example 2

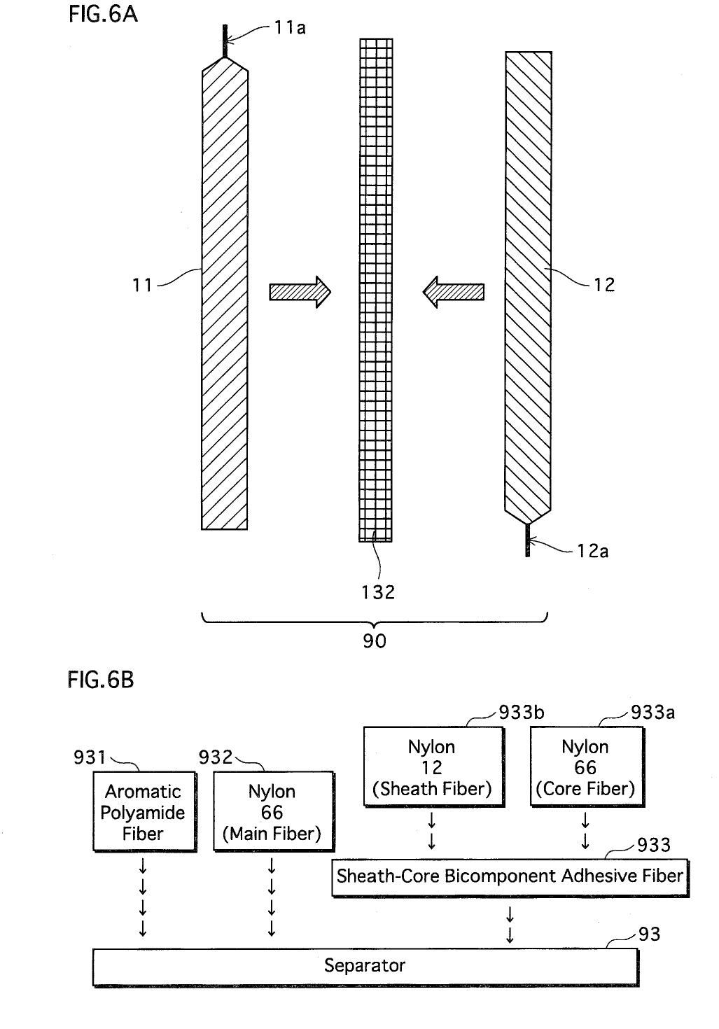

As illustrated in FIG. 6A, each battery sample of Comparative Example 2 was provided with an electrode assembly 90 having a separator 93 with a single-layer structure. Except for the electrode assembly 90, the battery samples of Comparative Example 2 were substantially identical in construction to the battery samples of Example and Comparative Example 1.

As shown in FIG. 6B, the separator 93 included in each battery sample of Comparative Example 2 was prepared in the following manner. First of all, aromatic-polyamide-fiber nonwoven fabric 931, main fiber 932 composed of Nylon 66, and sheath-core bicomponent fiber 933 were mixed at the ratio by mass of 1:5:5 approximately and dispersed to form a slurry. The slurry was then made into the separator 93 by using a known wet foaming method. Similarly to the above embodiment, the sheath-core bicomponent fiber 933 containing Nylon 66 as core fiber 933a and Nylon 12 as sheath fiber 933b were used to form the separator 93 of Comparative Example 2.

Note that the battery samples of Example and Comparative Examples 1 and 2 were substantially identical except for the respective separators. That is, each battery sample used substantially identical electrodes and identical components and contained the substantially same amount of electrolytic solution.

### (4) Experiment on Resistance to Short-Circuit

As described above, a total of 200 of battery samples were prepared for each of Example and Comparative Examples 1 and 2. The number of battery samples having caused an internal short-circuit by the time of completion were counted. Table 1 shows the results.

TABLE 1

| | Resistance to Short-Circuit | Internal Pressure |
|---|---|---|
| Example | 0 out of 200 | 0.29 MPa |
| Comparative Example 1 | 0 out of 200 | 1.34 MPa |
| Comparative Example 2 | 2 out of 200 | 0.21 MPa |

### (5) Measurement Experiment on Internal Pressure

The battery samples of Example and Comparative Examples 1 and 2 were each charged under −dV control by application of a charging current of 6 A. The maximum internal pressure at the time of charging was measured. The results are also shown in Table 1 above.

### (6) Content Ratio of Electrolytic Solution in Electrode Assembly

The battery samples of Example and Comparative Examples 1 and 2 were measured for the respective amounts of electrolytic solution contained in the electrode assembly 10, 80, and 90. Table 1 below shows the measurement results on a percentage basis.

TABLE 2

| | Percentage of Electrolytic Solution |
|---|---|
| | Contained in Negative Electrode |
| Example | 37.5% |
| Comparative Example 1 | 39.0% |
| Comparative Example 2 | 37.0% |

### (7) Discussion

As shown in Table 1, the results of experiment on the resistance to short-circuit show that a short-circuit had occurred in two of the battery samples of Comparative Example 2. None of the battery samples of Example and Comparative Example 1 were shorted out. Each of the two battery samples of Comparative Example 2 with a short-circuit was disassembled and examined. As a result, it was found that a broken piece of the electrodes had penetrated the separator 93.

The battery samples of Example and Comparative Example 1 were also disassembled after the experiment. As a result, broken pieces of the electrodes were also found inside the battery samples similarly to the battery samples with a short-circuit. Nevertheless, none of the separators 13 in the battery samples had been penetrated. This experimental results show that the separator 13 having a dual-layer structure is higher in resistance to short-circuit than the separator 93 of Comparative Example 2 having a single layer structure.

Also shown in Table 1, the measurement results of internal pressure exhibited a difference between Example and Comparative Example 1 although the separators 13 included in the respective one of the electrode assemblies 10 and 80 were identical in construction. This difference in internal pressure is believed to be caused depending on whether the separator 13 was disposed so that the main surface 13b constituted by the aromatic-polyamide-fiber nonwoven layer 132 faced toward the positive electrode 11 or toward the negative electrode 12. As shown in Table 2, the positional relation between the separator 13 and the negative electrode 12 affected the amount of electrolytic solution contained in the respective negative electrodes 12 of the electrode assemblies 10 and 80. More specifically, in Comparative Example 1 according to which the negative electrode 12 was disposed to confront the main-fiber nonwoven layer 131 of the separator 13, the percentage of liquid held in the negative electrode 12 is higher than that of Example approximately by 1.5 points.

All factors considered, the following points are noted regarding the battery samples of Comparative Example 1 having the negative electrode 12 disposed to confront the aliphatic polyamide fiber (nylon) contained as the main fiber 1311. That is, an excessive amount of electrolytic solution was supplied to the negative electrode 12 at the time of charging. As a result, contact between oxygen generated by the positive electrode 11 and the negative active material was obstructed, which resulted in a rise of internal pressure.

On the other hand, the battery samples according to Example exhibited a smaller rise in internal pressure than that of the battery samples of Comparative Example 1. This is believed to be due to the construction of the battery samples of Example. That is, the negative electrode 12 was disposed to confront the main surface 13b of the separator 13 constituted by the aromatic-polyamide-fiber nonwoven layer 132. As described above, the aromatic polyamide fiber 1321 contained the aromatic-polyamide-fiber nonwoven layer 132 whose property of holding electrolytic solution is relatively lower. As a result, oxygen generated by the positive electrode 11 was allowed to easily contact with the negative active material.

As the above experimental results show, by employing the aromatic polyamide fiber 1321 to form the aromatic-polyamide-fiber nonwoven layer 132, the separator 13 included in each battery sample of Example achieves to improve the strength. Thus, the thickness of the separator 13 is reduced while ensuring the resistance to short-circuit without the need to increase the content of aromatic polyamide. The thickness reduction of the separator 13 leads to another advantage of increasing the energy density. In addition, by disposing the positive electrode 11 into the above-described positional relation with the separator 13, a rise of the internal pressure at the time of charging is suppressed.

### 6. Supplemental Note

As illustrated in FIG. 1, the above embodiment relates to the alkaline secondary battery 1 having a cylindrical shape. In the experiments, cylindrical-shaped nickel-cadmium secondary batteries were employed. It should be naturally appreciated, however, that those batteries are mentioned merely as examples and without limitation. The present invention is applicable to any alkaline secondary batteries other than the specific alkaline secondary battery described above. For example, the present invention is applicable to a nickel-metal hydride battery as well as to a prismatic alkaline secondary battery.

Further, the above embodiment employs the electrode assembly 10 which is a rolled body made by winding electrodes and a separator. The present invention is not limited to such and an electrode assembly composed of a laminate of the electrodes and a separator may be applicable.

Still further, the above embodiment employs Nylon 66 (aliphatic polyamide fiber) as the main fiber 1311. Alternatively, however, any fiber material whose property of holding electrolytic solution is higher than that of the aromatic polyamide fiber 1321 is applicable.

Still further, the above embodiment employs the separator 13 having a dual-layer structure to ensure the above superiority. Alternatively, a separator having a plurality of main-fiber nonwoven layers may be employed.

Still further, the above Example employs sintered electrodes as the positive electrode 11 and the negative electrode 12. Alternatively, however, non-sintered electrodes may be employed.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An alkaline secondary battery, comprising:
an electrode assembly including a positive electrode, a negative electrode, and a separator, the positive and negative electrodes facing each other via the separator sandwiched therebetween; and
an electrolytic solution held in the electrode assembly, wherein
the separator contains aromatic polyamide fiber and fiber having higher property of holding the electrolytic solution than that of the aromatic polyamide fiber,
the separator includes a first layer containing the higher-liquid-holding fiber as a main component and a second layer containing the aromatic polyamide fiber at a density higher than that in the first layer, the first and second layers being exposed as first and second main surfaces of the separator respectively, and
in the electrode assembly, the separator is so disposed that the second main surface faces toward the negative electrode.

2. The alkaline secondary battery according to claim 1, wherein
the higher-liquid-holding fiber is aliphatic polyamide fiber.

3. The alkaline secondary battery according to claim 1, wherein
the first layer contains no aromatic polyamide fiber, and
the separator has a dual-layer structure composed of the first and second layers laminated in a thickness direction of the separator.
